(19) United States
(12) Patent Application Publication
(10) Pub. No.: US 2003/0149510 A1
(43) Pub. Date: Aug. 7, 2003

(54) Vending machine

(75) Inventor: Katsumi Takahashi, Nitta-gun (JP)

Correspondence Address: BANNER & WITCOFF, 1001 G STREET N W, SUITE 1100, WASHINGTON, DC, 20001, US

(73) Assignee: Sanden Corporation, Isesaki-shi (JP)

(21) Appl. No.: 10/355,191

(22) Filed: Jan. 31, 2003

(30) Foreign Application Priority Data
Feb. 4, 2002 (JP) 2002-27250
Feb. 4, 2002 (JP) 2002-27251

(51) Int. Cl. G06F 17/00

(52) U.S. Cl. 700/237

(57) ABSTRACT

When a non-contact IC card is detected, a card reader/writer immediately starts communications. The electronic money information stored on the non-contact IC card is transmitted to a control device of a vending machine. When merchandise is sold, the control device subtracts the price of the merchandise from the balance of the electronic money of the non-contact IC card, replaces the existing data with new data on the non-contact IC card, and releases the merchandise. To easily communicate with the non-contact IC card, the vending machine is provided with a holding unit.

### BACKGROUND OF THE INVENTION

(i) Field of the Invention

The present invention relates to a vending machine for selling merchandise using a non-contact IC card functioning as an electronic wallet in an electronic money system.

(ii) Description of the Related Art

For recent use in processing electronic money, a season pass, etc., there have been an increasing number of non-contact IC cards. Therefore, a vending machine capable of selling merchandise using a non-contact IC card functioning as an electronic wallet has been demanded.

Conventionally, a vending machine disclosed by Japanese Patent Laid-Open No. 2001-167331 has been well known as one of the above mentioned vending machines. The vending machine includes a card unit of a non-contact IC card and a sales start button. First, a card unit awaits the timing of emitting an electric wave from an antenna unit until a user presses the sales start button. When the sales start button is pressed, the vending machine enters a sales mode using a non-contact IC card. Then, when the user presses a merchandise selection button, the vending machine instructs the card unit to subtract a sales target merchandise set amount, and the card unit waits for the contact of the non-contact IC card with the antenna unit. When the non-contact IC card contacts the antenna unit of the card unit, they can communicate with each other, and the card unit confirms the balance etc. recorded on the non-contact IC card. As a result, when the sales selected merchandise can be allowed, the balance information about the non-contact IC card is updated using the card unit, the card unit notifies the vending machine of the completion of the subtraction, and the vending machine releases the merchandise out of the outlet. Thus, merchandise can be merchandised by the user pressing the sales start button, selecting the merchandise, making a payment using the non-contact IC card, thereby terminating the sales of merchandise by the vending machine using the non-contact IC card.

However, since the above mentioned conventional vending machine requires the procedure of first pressing the sales start button prior to selection of merchandise, the user feels no convenience because, as compared with the purchase of merchandise from the vending machine in cash without necessity to press the sales start button, an additional operation of pressing the sales start button is required to purchase merchandise using the non-contact IC card.

### SUMMARY OF THE INVENTION

The present invention aims at providing a vending machine capable of selling merchandise using a non-contact IC card in a simple operation.

To attain the above aim, the vending machine according to the present invention includes: a selector for selecting merchandise; a merchandise carrying-out mechanism for releasing the selected merchandise; a card unit communicable with a non-contact IC card and having a detector for detecting the non-contact IC card storing electronic money information; and a controller for control of the card unit to start communications with the non-contact IC card when the detector of the card unit detects the non-contact IC card, control of determining whether or not the selected merchandise can be sold according to the electronic money information received from the non-contact IC card when the selector selects the merchandise, and control of releasing the merchandise selected by the merchandise release when the merchandise can be sold.

According to the present invention, after the card unit detects the non-contact IC card, the user can purchase merchandise only by selecting desired merchandise. Therefore, the user can purchase merchandise from the vending machine using the non-contact IC card in the well-known procedure as in purchasing a ticket using a magnetic card from the ticket vending machine, thereby improving the convenience. Furthermore, without providing the above mentioned sales start button of the conventional vending machine, the communications between the card reader/writer and the non-contact IC card do not start until the detector detects the non-contact IC card, thereby improving the safe use of the non-contact IC card.

Furthermore, according to the present invention, the vending machine includes: a merchandise selector for selecting merchandise; a merchandise carrying-out mechanism for releasing the selected merchandise; a card unit communicable with the non-contact IC card storing electronic money information; and a controller for control of starting communications between the card unit and the non-contact IC card after the merchandise selector selects merchandise; control of determining whether or not the selected merchandise can be sold according to the electronic money information received from the non-contact IC card; and control of releasing the merchandise selected by the merchandise release when the merchandise can be sold.

According to the present invention, when the non-contact IC card is used, the merchandise can be purchased from the vending machine in only two operations, that is, the merchandise selector selecting desired merchandise, and the non-contact IC card approaching the area detectable by the card unit for communications between the card unit and the non-contact IC card.

The above mentioned object and the other objects, features, and merits of the present invention are clarified by the following descriptions and the attached drawings.

### BRIEF DESCRIPTION OF THE DRAWINGS

FIG. 1 shows the configuration of the vending machine according to a first embodiment of the present invention;

FIG. 2 shows the configuration of the card unit which is a substantial part of the vending machine according to the first embodiment of the present invention;

FIG. 3 is a front view-of the card unit provided with a holding unit according to the first embodiment of the present invention;

FIG. 4 is a side sectional view in the arrow A direction of the card unit provided with the holding unit according to the first embodiment of the present invention;

FIG. 5 is a flowchart of the procedure of purchasing merchandise according to the first embodiment of the present invention;

FIG. 6 shows the configuration of the card unit which is a central portion of the vending machine according to a second embodiment of the present invention;

FIG. 7 is a flowchart of the procedure of purchasing merchandise according to the second embodiment of the present invention; and

FIG. 8 shows the configuration of the vending machine according to another embodiment of the present invention.

### DESCRIPTION OF THE PREFERRED EMBODIMENTS

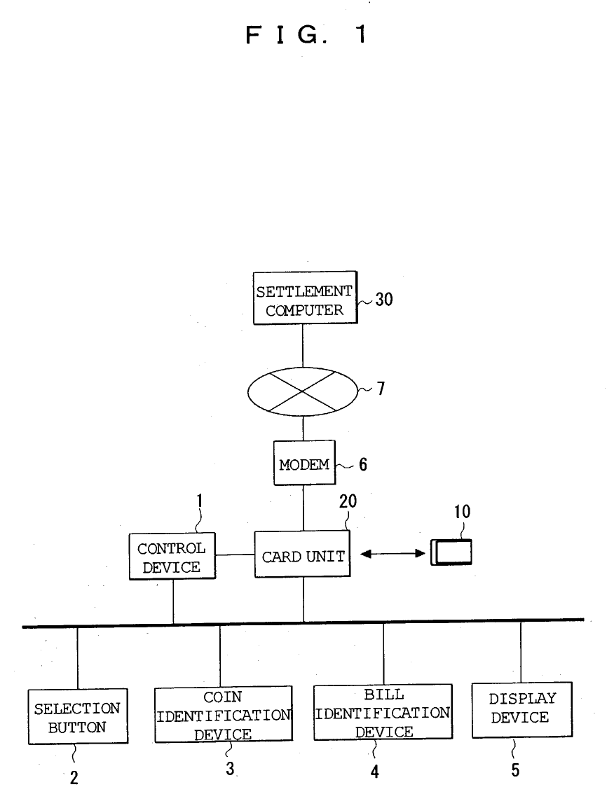

FIGS. 1 to 5 show a first embodiment of the vending machine to which the present invention is applied. The vending machine according to the present invention comprises: a control device 1 for performing a selling process on merchandise; a selection button 2 of the merchandise; a coin identification device 3 for identification of reception of coins; a bill identification device 4 for identification of reception of bills; a display device 5 for displaying the type of selected merchandise and the number of pieces of the selected merchandise; and a card unit 20 for reading and writing data by communicating with a non-contact IC card 10. Furthermore, it also comprises a cooling device and a heating device for use in managing the temperature for merchandise, a return lever, a merchandise carrying-out mechanism device, etc. (not shown in the attached drawings).

The control device 1 is connected to the selection button 2, the coin identification device 3, the bill identification device 4, the display device 5, and the card unit 20, and controls them to allow the user to purchase merchandise by freely selecting the use of cash or the non-contact IC card 10. Practically, when the user purchases merchandise in cash, the coin identification device 3 or the bill identification device 4 checks the amount of slotted money as in the common system, the user presses the merchandise selection button 2 to select merchandise, and the corresponding merchandise is released out of the outlet. When the user uses the non-contact IC card 10, as described later, the balance of the electronic money stored on the non-contact IC card 10 is read. The selection button 2 indicates the purchasable range based on the balance. When the user presses the selection button 2 and selects merchandise, a new balance is recorded on the non-contact IC card 10, and the merchandise is released. If the user cancels the purchase of the merchandise on the vending machine, then the cash is returned when the user paid cash for the merchandise, and the communications are stopped when the user used the non-contact IC card 10. In either case, the subsequent processes are cancelled.

The selection button 2 contains lamps. All lamps indicating purchasable range using the cash or the electronic money of the non-contact IC card 10 are lit. When the user presses the selection button 2 and selects merchandise, only the corresponding pressed lamp remains lit with the other lamps turned off. The coin identification device 3 identifies the coins slotted by the user, and the bill identification device 4 identifies the bills slotted by the user. The user can purchase the merchandise on the vending machine in cash.

The display device 5 displays the process state of the control device 1. Practically, when the user presses the selection button 2, the price of the selected merchandise is indicated. When cash is slotted, the amount of slotted money, and the amount of change, if any, are displayed. Furthermore, the contents of data about the balance etc. stored on the non-contact IC card 10 are also displayed.

The non-contact IC card 10 comprises an antenna unit for communications with the card unit 20 and a card processing unit for data processing (these components are not shown in the attached drawings). The card processing unit manages the encryption processing performed when an authenticating process is performed by the communications between the antenna unit and the card unit 20, and the personal information about the balance of the electronic money stored on the non-contact IC card 10 and the name of the owner of the non-contact IC card 10, and rewrites the data received by the antenna unit.

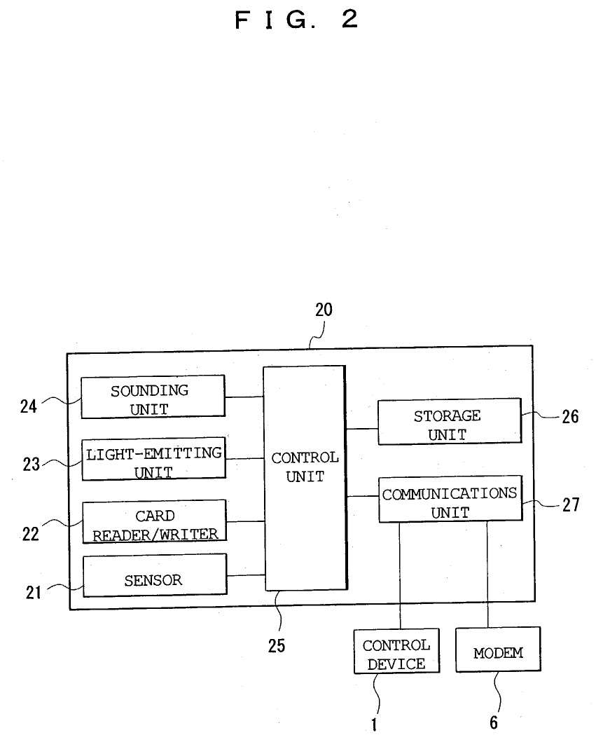

As shown in FIG. 2, the card unit 20 comprises a sensor 21 for detecting the non-contact IC card 10, a card reader/writer 22, a light-emitting unit 23, a sounding unit 24, a control unit 25, a storage unit 26, and a communications unit 27. Externally, it is provided with a holding unit 28 for holding the non-contact IC card 10 to be described later.

The sensor 21 comprises a reflective light sensor, and is built in the card unit 20. Then the non-contact IC card 10 approaches the sensor 21, the sensor 21 detects the card, and notifies the control unit 25 of the card. When the sensor 21 detects the non-contact IC card 10, the card reader/writer 22 is activated by the control unit 25. Then, the card reader/writer 22 supplies electric power to the non-contact IC card 10, and communicates with the antenna unit in an encryption system to read and write data stored on the non-contact IC card 10.

The light-emitting unit 23 comprises an LED etc. The light-emitting unit 23 blinks when the non-contact IC card 10 and the card reader/writer 22 become communicable. That is, the light-emitting unit 23 starts blinking when the user has the non-contact IC card 10 approach the area in which the non-contact IC card 10 can communicate with the card reader/writer 22 and the card reader/writer 22 and the non-contact IC card 10 actually communicate with each other, and keeps lit until the authenticating process on the non-contact IC card 10 terminates. The sounding unit 24 comprises a buzzer etc., and the buzzer sounds when the selling process is completed. The light-emitting unit 23 is provided at the upper part of the front side of the card unit 20, and the sounding unit 24 is built in the card unit 20 and indicates the process state of the non-contact IC card 10 to the user.

The control unit 25 controls the sensor 21, the card reader/writer 22, the light-emitting unit 23, the sounding unit 24, the storage unit 26, and the communications unit 27 in the card unit 20, and enables the communications with the non-contact IC card 10 and a settlement computer 30 in an encryption system. When the sensor 21 detects the non-contact IC card 10, the control unit 25 activates the card reader/writer 22 to communicate with the non-contact IC card 10. Based on the data stored on the non-contact IC card 10 and read by the card reader/writer 22, the unit performs the authenticating process and the selling process, and performs an operation of writing the new balance data to the non-contact IC card 10 after the process on the non-contact IC card 10 through the card reader/writer 22.

The storage unit 26 is used to temporarily store the data to be written by the control unit 25 to the non-contact IC card 10, and the data read from the non-contact IC card 10. The data stored by the storage unit 26 is communicated by the control unit 25. The communications unit 27 can communicate with the control device 1, and can also be connected to the settlement computer 30 through a modem 6 via a network 7.

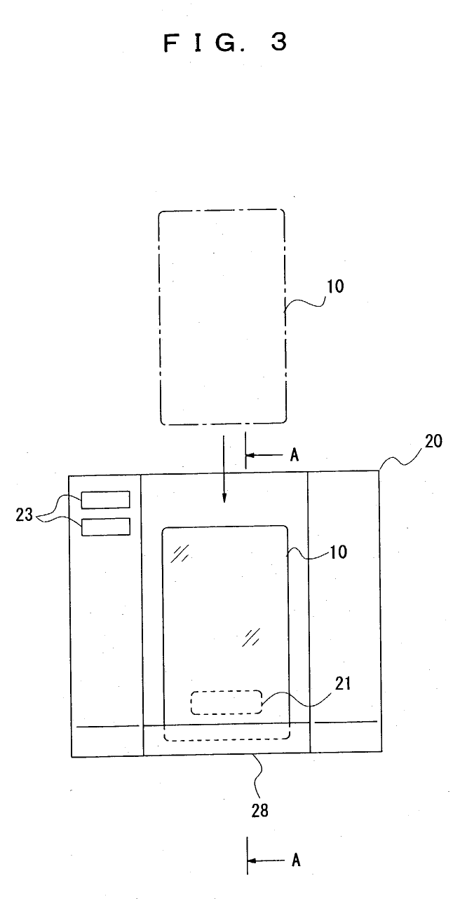

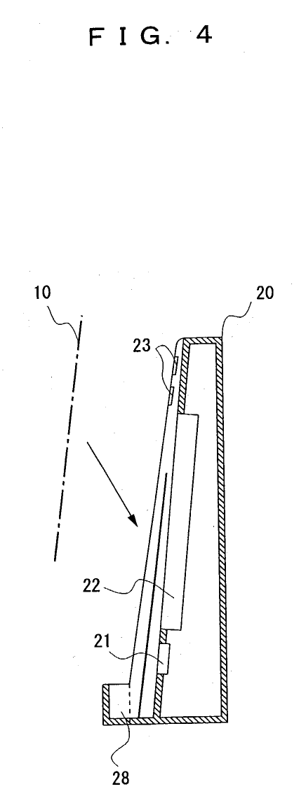

The holding unit 28 is provided at the lower part on the front side of the card unit 20 and before the sensor 21 as shown in FIG. 3. The non-contact IC card 10 placed on the holding unit 28 is immediately detected by the sensor 21 built in the card unit 20. Communications between the card and the card reader/writer 22 are started. As shown in FIG. 4, the holding unit 28 has an upward opening large enough to hold a unit such as a mobile phone containing a non-contact IC chip other than a card style unit having the function of the non-contact IC card 10.

When merchandise is purchased using the non-contact IC card 10, the settlement computer 30 receives data such as identification information, an amount of sales, etc. stored on the non-contact IC card 10 at a predetermined time period. Thus, the settlement computer 30 stores the data such as identification information, an amount of sales, etc. as a database, and manages the use state etc. for each non-contact IC card 10.

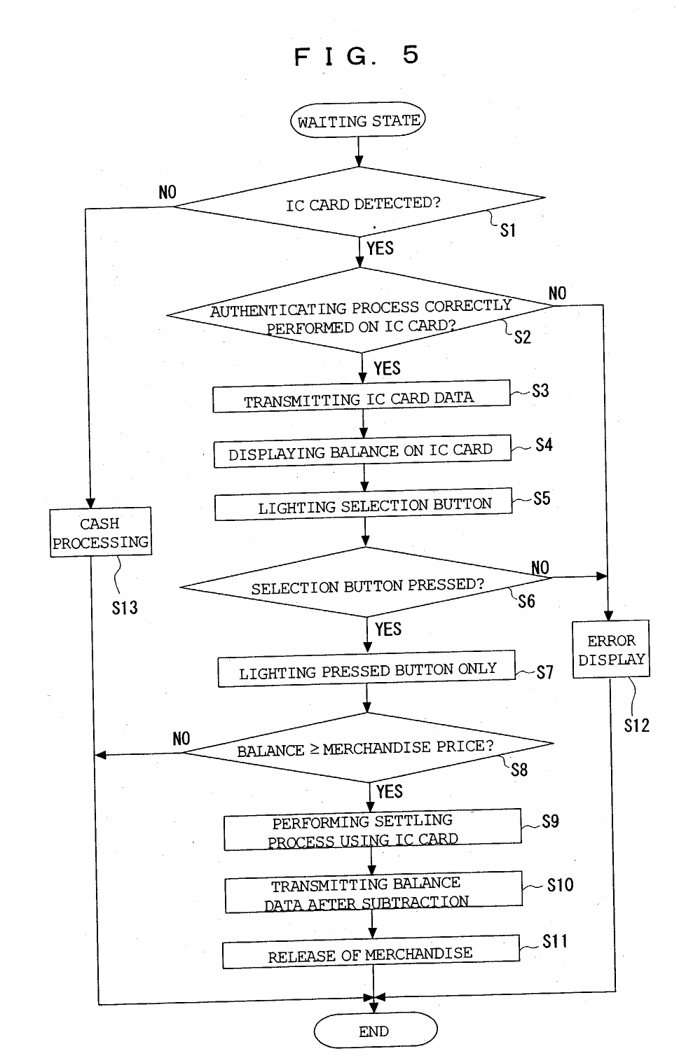

The operation of selling merchandise using the non-contact IC card 10 will be described below by referring to the flowchart shown in FIG. 5.

Until the sensor 21 detects the non-contact IC card 10, the card unit 20 is set in a waiting state. When the user places the non-contact IC card 10 on the holding unit 28, after detection, the card reader/writer 22 starts communications (step S1). Then, according to the identification information about the non-contact IC card 10 read by the card reader/writer 22, the control unit 25 performs the authenticating process (step S2). If the authenticating process is correctly performed, then the control device 1 transmits the data of the non-contact IC card 10 through the communications unit 27 10 to the control device 1 of the vending machine (step S3). The control device 1 allows the display device 5 to display the balance of the electronic money of the non-contact IC card 10 (step S4). Furthermore, it turns on all lamps of the selection buttons 2 of merchandise indicating the purchasable range for the balance (step S5). It determines whether or not the user has pressed the selection button 2 of desired merchandise from among the selection buttons 2 (step S6). If yes, then it turns on only the lamp of the corresponding selection button 2 with the others turned off such that the user cannot select any more merchandise (step S7). The control device 1 determines whether or not ‘balance≧merchandise price’ holds (step 58). If the balance of the electronic money is equal to or larger than the merchandise price, then the settling process of ‘balance−merchandise price’ is performed (step S9). After the settling process, new balance data is transmitted to the card unit 20 through the communications unit 27 (step S10). The card unit 20 writes the data of the new balance to the non-contact IC card 10 using the card reader/writer 22. Additionally, the control device 1 also allows the display device 5 to display the new balance, releases the merchandise out of the merchandise release device to provide the merchandise for the user (step S11).

When the authenticating process cannot be correctly performed in the authenticating process in step S2, and when the selection button 2 is not pressed in step S6, an error indicator is displayed on the light-emitting unit 23, and the sounding unit 24 raises a warning sound (step S12).

When money is received in addition to the non-contact IC card 10 in step S1 and ‘balance<merchandise price’ holds in step S8, it is determined that the payment is made without the non-contact IC card 10, for example, in cash etc., and the money can be accepted (step S13). That is, as described above, after the user slots money into the coin identification device 3 or the bill identification device 4, the amount of slotted money is displayed on the display device 5, and the selection button 2 is lit. After the user presses the selection button 2, the corresponding merchandise is released.

Thus, according to the present invention, the user places the non-contact IC card 10 on the holding unit 28 equipped with the card unit 20, and presses the selection button 2 for desired merchandise from among the lit selection buttons 2, thereby easily purchasing the merchandise. Since no power is supplied to the card reader/writer 22 for communications with the non-contact IC card 10 until the sensor 21 detects the non-contact IC card 10, no communications are mistakenly established with the non-contact IC card 10.

Furthermore, the user can purchase merchandise on the vending machine in cash and by combination of the non-contact IC card 10 and cash.

Since the process state of the non-contact IC card 10 and the balance of the electronic money are displayed, the user can easily and correctly use the non-contact IC card 10.

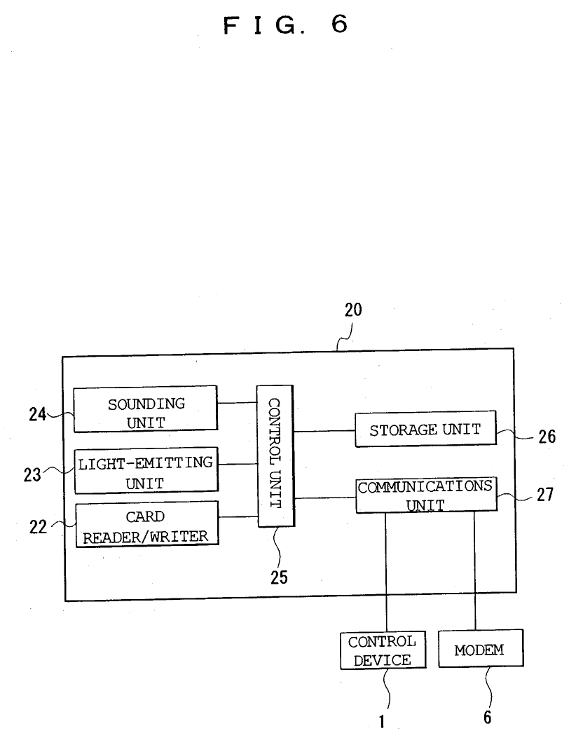

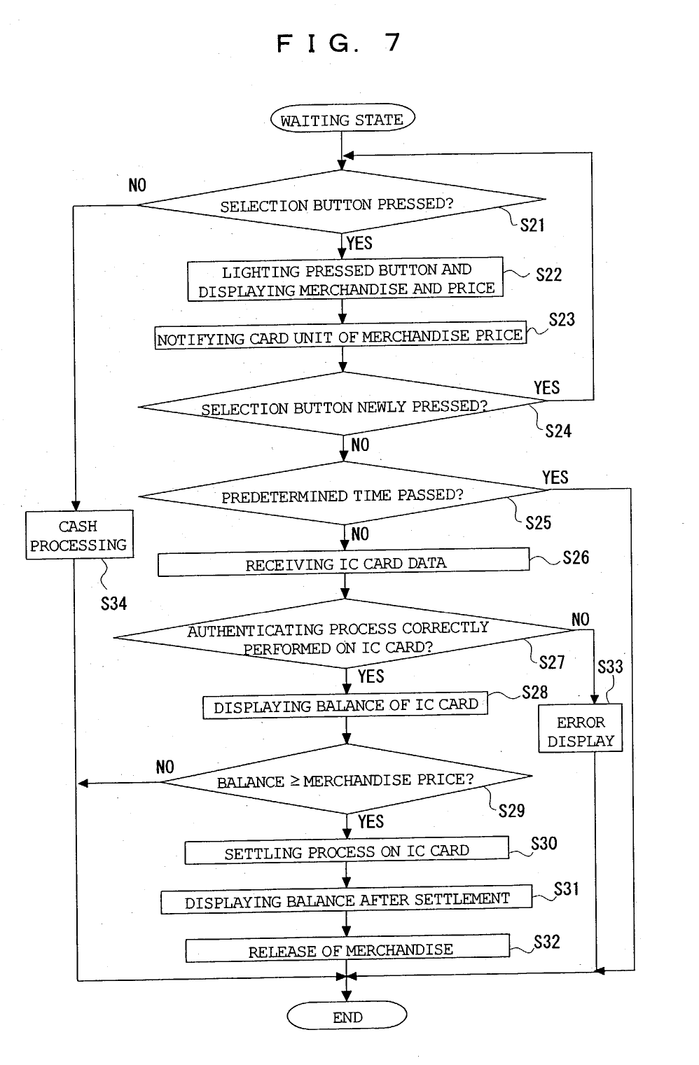

A second embodiment of the vending machine according to the present invention will be described below by referring to FIGS. 6 and 7. The same configuration as in the first embodiment is represented by the same reference numerals, and the explanation is omitted.

The vending machine according to the present embodiment comprises, as according to the first embodiment, the control device 1, the merchandise selection button 2, the coin identification device 3 for identification of slotted coins, the bill identification device 4 for identification of slotted bills, and the display device 5 displaying the type of selected merchandise and the number of pieces of the selected merchandise. Furthermore, it also comprises the card unit 20 for processing the non-contact IC card 10 connected to the control device 1, the cooling device and the heating device for management of the temperature of merchandise, the merchandise release device, etc. (not shown in the attached drawings).

The selection button 2 is provided corresponding to each piece of merchandise contained in the vending machine, and has a built-in lamp. When the selection button 2 is pressed, the lamp is turned on to show that the corresponding merchandise has been selected. If the lit selection button 2 is pressed again, then the lamp is turned off to show that the selection of the merchandise has been cancelled.

The display device 5 displays not only the price and the number of pieces of the merchandise selected by the user, but also the contents of the data of the non-contact IC card 10 read by the card unit 20 to be described later. That is, only the display device 5 displays the price of the merchandise in the vending machine, the electronic money information, etc. stored on the non-contact IC card 10.

The control device 1 controls the selection button 2, the coin identification device 3, the bill identification device 4, the display device 5, and the card unit 20 to enable the non-contact IC card 10 and cash to be used in combination on the vending machine. Practically, if money is slotted before pressing the selection button 2, the lamps of the selection buttons 2 in the purchase range are turned on. If the selection button 2 is pressed and merchandise is selected, then the corresponding merchandise is released. When the selection button 2 is pressed before slotting cash, it is determined that the payment is made using the non-contact IC card 10. As described later, the control device 1 activates the card unit 20 to allow it to communicate with the non-contact IC card 10. The control device 1 performs, based on the identification information and electronic money information of the data of the non-contact IC card 10 read by the card unit 20, the authenticating process and the process of subtracting ‘balance−merchandise price’, the process of writing the resultant new balance to the non-contact IC card 10, and the process of transmitting the sales result to the settlement computer 30 through the communications unit 27.

The card unit 20 comprises the card reader/writer 22, the light-emitting unit 23, the sounding unit 24, the control unit 25, the storage unit 26, and the communications unit 27 as shown in FIG. 6. It is set in the waiting state until the user presses the selection button 2. When the selection button 2 is pressed, the card unit 20 is activated by the control device 1.

The control unit 25 controls the card reader/writer 22, the light-emitting unit 23, the sounding unit 24, the storage unit 26, and the communications unit 27 in the card unit 20. When the user presses the selection button 2 before slotting cash, the control unit 25 issues the following instructions. That is, it allows the card reader/writer 22 to provide electric power for the non-contact IC card 10 to communicate with the non-contact IC card 10 in an encryption system. Then, during the communications, the control unit 25 controls the light-emitting unit 23 and the sounding unit 24 to transmit a notification about the process state of the non-contact IC card 10.

The operation of the control device 1 during the purchase of merchandise using the non-contact IC card 10, which is the gist of the present invention, will be described below by referring to the flowchart shown in FIG. 7.

As described above, in the sales waiting state, the card unit 20 is not activated. The control device 1 determines whether the user slots cash using the coin identification device 3 or the bill identification device 4 or the user presses the selection button 2 before slotting cash (step S21). If the selection button 2 is pressed before slotting cash, then the control device 1 recognizes that merchandise is purchased by using the non-contact IC card 10. The control device 1 activates the card unit 20, allows it to communicate with the non-contact IC card 10, turns on the pressed selection button 2, and displays the price of the selected merchandise on the display device 5 (step S22). Then, the control device 1 notifies the card unit 20 of the price of the selected merchandise through the communications unit 26 (step S23). When the user selects plural pieces of merchandise, the control device 1 turns on the selection button 2 each time the selection button 2 of another piece of merchandise is pressed, and has the display device 5 display the type of the merchandise and the total amount of money to be paid. Thus, it is determined depending on the operation of pressing the button whether or not plural pieces of merchandise are purchased (step S24). The predetermined elapsed time from the last pressing the selection button 2 by the user is measured by the control device 1 (step S25). If the user moves the non-contact IC card 10 to the communicable area with the card reader/writer 22 within a predetermined time, the card unit 20 immediately starts communications. The control device 1 receives the data stored on the non-contact IC card 10 from the card unit 20 (step S26). Then, the control device 1 performs the authenticating process and checks the balance based on the data of the non-contact IC card 10 (step S27). When the authenticating process is correctly performed, then the control device 1 allows the display device 5 to display the balance of the electronic money stored on the non-contact IC card 10 (step S28). The control device 1 determines whether or not the balance of the electronic money exceeds the total amount of the selected merchandise (step S29). If ‘balance≧total amount of merchandise’ holds, then the settling process is performed by subtracting the amount of merchandise from the balance (step S30). The control device 1 indicates the new balance data after the settlement to the card unit 20 to write the data to the non-contact IC card 10, and has the display device 5 display the new balance (step S31). After the settlement, the merchandise is released out of the outlet and provided for the user (step S32).

In step S25, if the user does not press the selection button 2 or have the non-contact IC card 10 approach the communicable area of the card reader/writer 22 before a predetermined time passes after the merchandise selection button 2 is pressed, then the control device 1 terminates the selling operation. If the authenticating process is not performed on the non-contact IC card 10 in step S27, the process is suspended. At this time, a blinking error notification is displayed in red or any visible color as a warning by the light-emitting unit 23 (step S33).

When cash is slotted before pressing the selection button 2 in step S21, the settling process in cash not using the non-contact IC card 10 is performed. The process in cash is performed as in the common method. That is, when the user slots a predetermined amount in cash using the coin identification device 3 or the bill identification device 4, the total amount of slotted money is displayed on the display device 5, and the selection buttons 2 of the merchandise in the purchasable range are turned on. If the user presses the selection button 2 for the desired merchandise, then the corresponding merchandise is released. In step S29, it is possible for the user to slot the shortfall in cash for the non-contact IC card 10 to successfully purchase the merchandise. If the user slots the cash as the shortfall for the non-contact IC card 10, then the coin identification device 3 or the bill identification device 4 can accept it in the process as in step S21, the added amount is displayed on the display device 5, thereby releasing the merchandise (step S34).

Thus, according to the present embodiment, the user can purchase merchandise by two operations only, that is, pressing the selection button 2 for the desired merchandise before slotting cash, and having the non-contact IC card 10 approach the detectable area of the card unit 20. As a result, merchandise can be purchased on the vending machine using the non-contact IC card 10 in a simple operation.

Unless the non-contact IC card 10 can be detected by the card unit 20, communications cannot be started. Therefore, the non-contact IC card 10 cannot be used in the sales process when the user has no intention of purchasing merchandise.

Furthermore, the communications state between the non-contact IC card 10 and the card unit 20 is displayed by light and sound, and the balance of the electronic money is displayed on the display device displaying the price of the selected merchandise, thereby appropriately notifying the user of the process state of the non-contact IC card.

The preferred embodiments described in the present specifications are only examples, and the present invention is not limited to these embodiments. The scope of the present invention is disclosed by the attached claims, and the present invention includes all variations relating to the claims.

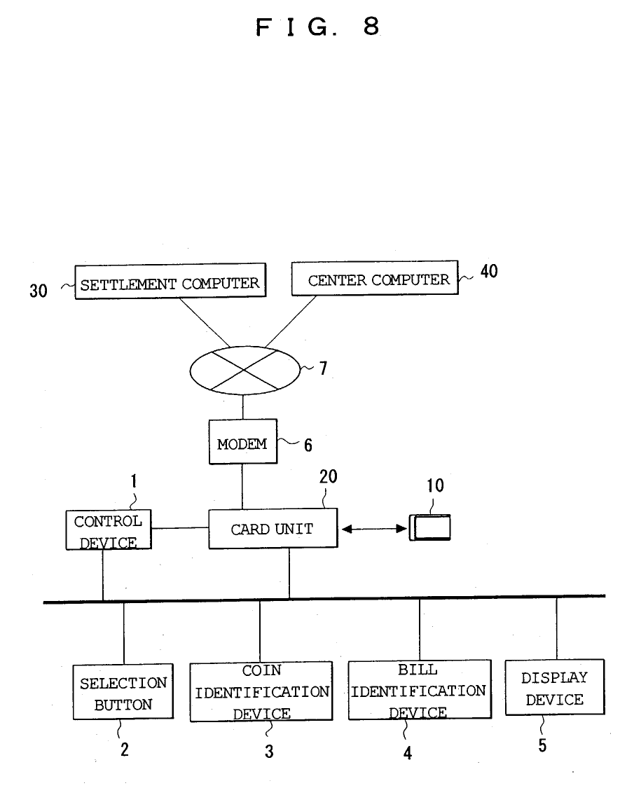

For example, as shown in FIG. 8, if a center computer 40 of the manager of the merchandise sales and operations of a vending machine can be connected via the network 7, a communications terminal such as a mobile phone etc. not including the non-contact IC card 10 or a non-contact IC chip can be used in purchasing merchandise using the communications facilities without cash.

Furthermore, according to the first and second embodiments, a non-contact IC card is used, but the effect of the present embodiments can be obtained using a communications terminal such as a mobile phone including a non-contact IC chip.

Additionally, according to the first and second embodiments, merchandise is purchased using the electronic money stored on the non-contact IC card 10, but different services can be provided depending on each user by, for example, selling merchandise free of charge to a specified user during the authenticating process.

What is claimed is:

1. A vending machine, comprising:
a selector for selecting merchandise;
a merchandise carrying-out mechanism for releasing the selected merchandise; a card unit communicable with a non-contact IC card and having
a detector for detecting the non-contact IC card storing electronic money information; and
a controller for control of said card unit to start communications with the non-contact IC card when said detector of the card unit detects the non-contact IC card, control of determining whether or not the selected merchandise can be sold according to electronic money information received from the non-contact IC card when said selector selects the merchandise, and control of releasing the merchandise selected by said merchandise release when the merchandise can be sold.

2. The vending machine according to claim 1, wherein:
said card unit comprises a holding unit for holding the non-contact IC card; and
said detector detects the non-contact IC card when the non-contact IC card is held on said holding unit.

3. The vending machine according to claim 1, wherein
said card unit comprises a communication apparatus for connection via a network to a settlement computer for making settlement of the non-contact IC card.

4. The vending machine according to claim 1, further comprising a cash acceptor for accepting money in cash.

5. The vending machine according to claim 1, wherein
said card unit comprises a display for displaying a processing state of the non-contact IC card.

6. The vending machine according to claim 1, further comprising
the display for displaying a price of the selected merchandise and a balance recorded on a non-contact IC card.

7. The vending machine according to claim 1, wherein
said controller sells merchandise based on data received from a communications terminal via a network.

8. The vending machine according to claim 2, wherein
said card unit comprises the communication apparatus for connection via a network to a settlement computer for making settlement of the non-contact IC card.

9. The vending machine according to claim 2, wherein
said card unit comprises the display for displaying a processing state of the non-contact IC card.

10. A vending machine, comprising:
a merchandise selector for selecting merchandise; a merchandise carrying-out mechanism for releasing the selected merchandise;
a card unit communicable with a non-contact IC card storing electronic money information; and
a controller for control of starting communications between said card unit and the non-contact IC card after said merchandise selector selects merchandise; control of determining whether or not the selected merchandise can be sold according to electronic money information received from the non-contact IC card; and control of releasing the merchandise selected by the merchandise release when the merchandise can be sold.

11. The vending machine according to claim 10, wherein
said controller cancels subsequent processes when the non-contact IC-card does not start to communicate with said card unit within a predetermined time after said merchandise selector selects the merchandise.

12. The vending machine according to claim 10, further comprising
a communication apparatus for connection via a network to a settlement computer for making a payment using a non-contact IC card.

13. The vending machine according to claim 10, further comprising
a cash acceptor for accepting money in cash.

14. The vending machine according to claim 10, wherein
said card unit comprises the display for displaying a processing state of the card unit.

15. The vending machine according to claim 10, further comprising
the display for displaying a balance recorded on the non-contact IC card and a price of the selected merchandise.

16. The vending machine according to claim 10, wherein
said controller sells merchandise based on data received from a communications terminal via a network.

17. The vending machine according to claim 11, further comprising
a communication apparatus for connection via a network to a settlement computer for making settlement of the non-contact IC card.

18. The vending machine according to claim 11, wherein
said card unit comprises the display for displaying a processing state of the card unit.
